(19) United States
(12) Patent Application Publication
(10) Pub. No.: US 2016/0004985 A1
(43) Pub. Date: Jan. 7, 2016

(54) Prioritizing Proposal Development Under Resource Constraints

(71) Applicant: International Business Machines Corporation, Armonk, NY (US)

(72) Inventors: Jeanette L. Blomberg, Portola Valley, CA (US); Neil Boyette, Oregon City, OR (US); Anca A. Chandra, Los Gatos, CA (US); Sechan Oh, Stanford, CA (US); Hovey Raymond Strong, JR., San Jose, CA (US)

(21) Appl. No.: 14/322,199

(22) Filed: Jul. 2, 2014

(51) Int. Cl. G06Q 10/06

(52) U.S. Cl. CPC G06Q 10/06313; G06Q 10/067

(57) ABSTRACT

Methods, systems, and articles of manufacture for prioritizing proposal development under resource constraints are provided herein. A method includes clustering multiple items of historical proposal development data into clusters based on one or more parameters, wherein said historical data comprise multiple prior proposal requests; generating a logistic regression model for time sensitivity associated with each of the prior proposal requests within each cluster; simulating each of the prior proposal requests (i) based on the corresponding logistic regression model and (ii) under each of multiple prioritization policies to determine an expected revenue measure for each of the prior requests under each of the prioritization policies; selecting a prioritization policy from the multiple prioritization policies based on said expected revenue measures; and computing a priority score for each proposal request in a given set of proposal requests based on application of the selected prioritization policy to each request in the given set.

### FIELD OF THE INVENTION

Embodiments of the invention generally relate to information technology (IT), and, more particularly, to prioritization techniques.

### BACKGROUND

In business-to-business (B2B) contracting such as IT service contracting, supplier firms commonly develop proposals in response to a request from a buyer firm. Proposal development in B2B contracting can be a time-consuming task, as well as a task that often requires input from experienced experts such as, for example, sales representatives and technical solution architects. Also, because the capacity for proposal development is fixed, supplier firms often face a shortage of available capacity when there are multiple deals for which to bid. In such instances, firms attempt to prioritize deals to maximize the total expected signing value. Postponing the development of a proposal, however, reduces the chance of winning (that is, being granted) the deal, and delays may have different levels of impact on different types of deals.

Accordingly, a need exists for techniques that incorporate a measure of time-sensitivity in determining prioritization rules to maximize a total expected signing.

### SUMMARY

In one aspect of the present invention, techniques for prioritizing proposal development under resource constraints are provided. An exemplary computer-implemented method can include steps of clustering multiple items of historical proposal development data into one or more clusters based on one or more parameters, wherein said historical proposal development data comprise multiple prior proposal requests; generating a logistic regression model for time sensitivity associated with each of the prior proposal requests within each of the one or more clusters; simulating each of the prior proposal requests (i) based on the corresponding logistic regression model and (ii) under each of multiple prioritization policies to determine an expected revenue measure for each of the prior proposal requests under each of the prioritization policies; selecting a prioritization policy from the multiple prioritization policies based on said expected revenue measures; and computing a priority score for each proposal request in a given set of proposal requests based on application of the selected prioritization policy to each proposal request in the given set.

In another aspect of the invention, an exemplary computer-implemented method to can include steps of clustering multiple items of historical transaction data into one or more clusters based on transaction type, wherein said historical transaction data comprise multiple prior proposal requests; generating a logistic regression model for time sensitivity associated with each of the prior proposal requests within each of the one or more clusters; simulating each of the prior proposal requests across the one or more clusters (i) based on the corresponding logistic regression model and (ii) under each of multiple prioritization policies to determine an expected revenue measure for each of the prior proposal requests under each of the prioritization policies; selecting a prioritization policy from the multiple prioritization policies for each transaction type based on said expected revenue measure for each of the proposal requests across the one or more clusters; and computing a priority score for each request in a given set of requests based on (i) identification of a transaction type associated with each request and (ii) implementation of the selected prioritization policy for said transaction type associated with each request.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system components, according to an embodiment of the invention;

FIG. 2 is a flow diagram illustrating techniques according to an embodiment of the invention; and

FIG. 3 is a system diagram of an exemplary computer system on which at least one embodiment of the invention can be implemented.

### DETAILED DESCRIPTION

As described herein, an aspect of the present invention includes prioritizing proposal development under resource constraints. As noted herein, in contexts such as B2B contracting, responding in a timely manner to a buyer firm's request for proposal commonly affects the chances of a successful deal outcome. Additionally, when there are multiple deals for which a supplier firm can bid, the supplier firm may have a limited amount of resources to develop multiple proposals. Accordingly, as detailed herein, at least one embodiment of the invention includes identifying a prioritization rule among a set of prioritization rules using analytical methods so as to maximize the total expected signing.

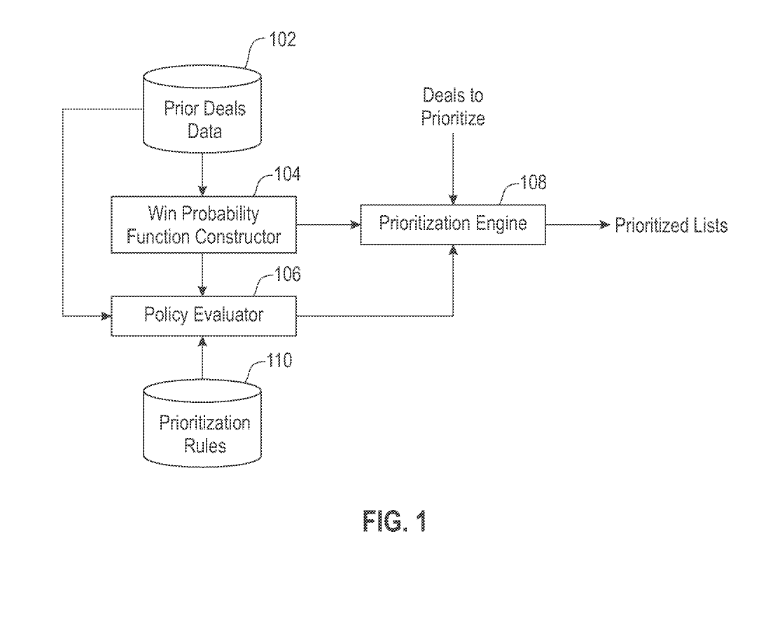

FIG. 1 is a diagram illustrating system components, according to an embodiment of the present invention. By way of illustration, FIG. 1 depicts a win probability function constructor module 104, a policy evaluator module 106, and a prioritization engine module 108. The win probability function constructor module 104 constructs a function that estimates the win probability of deals using historical data associated with prior deals obtained, for example, from a prior deals data repository 102. The policy evaluator module 106 evaluates different prioritization rules from a prioritization rules repository 110 and determines the rule(s) that maximizes the total expected signing value for the noted deals based on the estimated win probabilities. The prioritization engine module 108 takes the noted deals that are waiting for capacity assignment as inputs and assigns priority scores thereto using the prioritization rule(s) obtained from the policy evaluator module 106 to ultimately output a prioritized list of deals.

For a given deal, at least one embodiment of the invention includes defining the time between the receipt of the request for proposal and the completion of proposal development as the response time. Additionally, when determining the priority of outstanding deals, the impact of delaying capacity assignment on deal outcomes is taken into consideration. As further noted, at least one embodiment of the invention includes constructing a function via win probability function constructor module 104 that estimates the win probability of deals by analyzing time sensitivities of each relevant deal using prior deals data.

In such an embodiment of the invention, prior deals data are gathered and/or obtained from data repository 102. Such data for each deal can include, for example, (i) deal context, (ii) contract value (total estimated revenue), (iii) request receipt date, (iv) proposal development start date, (v) proposal completion date, and (vi) deal outcome (win or loss, for instance). The deal context can include factors that have an impact on the time sensitivity of a given deal such as, for example, the industry of the buyer firm and the deal type or category.

Additionally, at least one embodiment of the invention includes clustering the set of prior history deals based on time sensitivity, such as detailed, for example, in U.S. Pat. No. 6,397,166 to Leung et al., the disclosure of which is incorporated by reference herein in its entirety.

Also, at least one embodiment of the invention includes conducting a regression test on the obtained prior deals data. To construct a win probability function, the win probability function constructor module 104 can utilize, for example, recent data based on the completed date (for example, all deals completed during the last year). The relevant prior deals are then clustered into one or more groups, wherein each group is associated by similar values of deal context, contract value, and/or response time. Attributes included in the deal context, as noted herein, can be categorical as well as numeric. Accordingly, at least one embodiment of the invention includes applying one or more clustering algorithms developed for mixed numeric and categorical attributes.

Further, for each cluster or group, at least one embodiment of the invention includes constructing a binary logistic regression model. In at least one example embodiment, the independent variable for such a model is the deal outcome (win=1, loss=0), and the dependent variable for such a model is the response time. The regression test determines the binary logistic function of the response time that best fits the historical deals outcome for the given cluster. Two constants, a and b, are obtained as the outcome of the binary logistic regression test, wherein a is the constant coefficient, and b is the coefficient for the response time. For a given response time y, the probability of a winning deal is then given as:

Prob (win|response time=y)=1/(1+exp(−a−b*y))

Further, in at least one embodiment of the invention, if a pre-specified goodness-of-fit measure, such as the R² of the regression test, is above a certain threshold, the model is accepted for the given cluster. Otherwise, deals can be further clustered into sub-clusters until each cluster shows a sufficiently strong goodness-of-fit measure. After constructing all clusters, the win probability function is defined as follows. For a given cluster x, the constant coefficient of the binary logistic test is a(x), and the coefficient for the response time is b(x). Accordingly, the win probability function is defined as:

Prob(win|cluster=x, response time=y)=1/(1+exp(−a(x)−b(x)*y))

The function provides an estimate of the win probability for each deal based on the deal cluster and the response time.

Referring back to FIG. 1, the policy evaluator module 106 compares the performance of different prioritization rules and determines an optimal rule or rules using the win probability function and prior deals data. As such, in at least one embodiment of the invention, the policy evaluator module 106 takes three inputs: (i) a win probability function from the win probability function constructor module 104, (ii) prior deals data from repository 102, and (iii) a list of prioritization rules (for example, the list of prioritization rules that the user wants to evaluate) from depository 110. A default set of prioritization rules can also be provided, wherein examples of such prioritization rules can include prioritization by the request received date, prioritization by the contract value, prioritization by the win probability, and prioritization by the expected signing value (that is, win probability*contract value).

Based on the noted inputs, the policy evaluator module 106 computes past capacity levels based on prior deals data. For each day of the given time period in the past, the policy evaluator module 106 counts the number of deals having (i) a proposal development start date that is the same as or earlier than the given day, as well as (ii) a proposal completion date that is the same as or later than the given day. The total number of deals defines the number of deals (that is, capacity) that were available on each day of the past time period. For each deal, the difference between the proposal completion date and the proposal development start date defines the number of required days to develop a proposal for the given deal. It can also be noted that the number of required days can be different from the response time because the response time can also include a waiting period in some instances.

Additionally, the policy evaluator module 106 computes the total expected signing under each prioritization rule using a simulation engine. For each prioritization rule, the policy evaluator module 106 preferably creates four empty queues: (i) a future deals queue, (ii) a waiting queue, (iii) a work-in-progress queue, and (iv) a completed deals queue. An initiation step of an algorithm implemented via at least one embodiment of the invention includes adding all prior deals to the future deals queue. Also, for each day of the given time period, the policy evaluator module 106 processes the following steps:

1. Move a deal if the request received date is today.

2. Apply prioritization rule.

3. Move by the amount of available capacity. For deals left in the waiting queue, increase the waiting time by one day.

4. For each deal, decrease the number of required days by one day. If the number of required days left for a given deal is zero, move the deal to the completed deals queue and record the completion date.

After the simulation engine moves all deals to the completed deals queue, the policy evaluator module 106 computes the total expected signing. For each completed deal z, a new proposal completion date is determined via the given prioritization rule. Additionally, y(z)=new completed date−request received date, which indicates the response time for deal z under the given prioritization rule. The cluster to which deal z ultimately belongs is denoted by x(z), and the total contract value of deal z is denoted by TCV(z). Accordingly, the total expected signing under the given prioritization rule is the summation of TCV(z)*Prob(win|cluster=x(z), response time=y(z)) across all deals. After computing the total expected signing value for all prioritization rules, the policy evaluator module 106 selects and/or identifies the policy that yields the largest total expected signing as the best or optimal prioritization rule(s).

Note that under the same prioritization rule, the priority score of a deal may change over time because the win probability decreases as the waiting time increases. Hence, in at least one embodiment of the invention, priority scores are updated at a given temporal interval (for example, daily) for every deal in the waiting queue.

When different types of skills (or capacity) are required for proposal development, at least one embodiment of the invention can include extending the policy evaluator module 106 by introducing multiple sequential works-in-progress and waiting queues, as further described herein. Different prioritization rules can also be applied for each work step.

Using the best prioritization rule(s) identified by the policy evaluator module 106, the prioritization engine module 108 computes priority scores for all current deals that are waiting for capacity assignment. In at least one embodiment of the invention, the method to compute the priority score is similar to the computation techniques detailed above in connection with the policy evaluator. More specifically, for each deal z currently in the waiting queue, the cluster to which this deal belongs is identified based on the clustering result as detailed above using (i) an estimated contract value, (ii) the number of waiting days, (iii) an estimated number of days required for proposal development, and (iv) the deal context. The contract value and the number of required days are estimated values because they are realized when the proposal development is completed in the future. Additionally, at least one embodiment of the invention includes applying the best prioritization rule(s) to compute the priority score of this deal.

The list of prioritization rules provided by the policy evaluator module 106 can include trivial prioritization rules as well as the marginal penalty policy. The marginal penalty policy assesses priority scores based on the marginal penalty of delaying the proposal development of deals. By way of example, for a deal z with cluster x(z), a total contract value TCV(z), and a number of required days for proposal development y(z), suppose that the deal has waited w(z) days in the waiting queue. If the given firm starts developing the proposal today, then the expected signing value is given as: TCV(z)*Prob (win|cluster=x(z), response time=y(z)+w(z)).

If the given firm starts working on this deal tomorrow (that is, one day later), then the expected signing is given as: TCV(z)*Prob(win|cluster=x(z), response time=y(z)+w(z)+1). The difference between the two values is the marginal penalty of delaying the proposal development, and the marginal penalty policy prioritizes deals based on this metric.

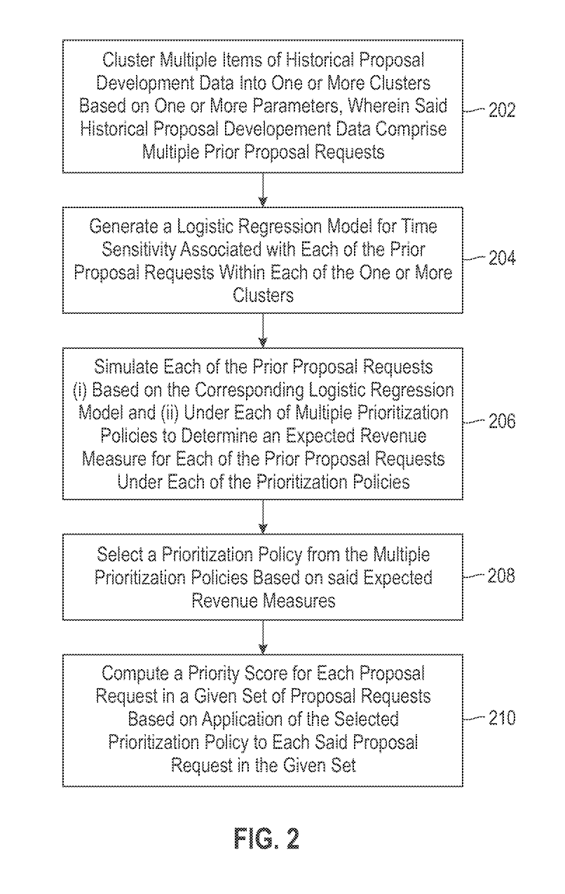

FIG. 2 is a flow diagram illustrating techniques according to an embodiment of the present invention. Step 202 includes clustering multiple items of historical proposal development data into one or more clusters based on one or more parameters, wherein said historical proposal development data comprise multiple prior proposal requests. Step 204 includes generating a logistic regression model for time sensitivity associated with each of the prior proposal requests within each of the one or more clusters.

Generating a logistic regression model can include utilizing (i) a proposal request context measure, (ii) a value associated with a given proposal request, and (iii) a response time measure of the given proposal request as inputs. Additionally, such a step can further include generating a win probability of the given proposal request as an output. Also, as noted herein, response time includes the time period between a request receipt date and a proposal completion date.

Step 206 includes simulating each of the prior proposal requests (i) based on the corresponding logistic regression model and (ii) under each of multiple prioritization policies to determine an expected revenue measure for each of the prior proposal requests under each of the prioritization policies. As detailed herein, the prioritization policies can include a marginal penalty policy that determines a priority score based on a reduction in expected revenue of a given proposal request caused by delaying capacity allocation to the given proposal request by a given temporal interval.

Simulating can include computing available capacity for proposal development for a duration of simulation based on a proposal development start date and a completion date of each of the multiple prior proposal requests. Additionally, at least one embodiment of the invention can include computing, for each day of simulation, a priority score for each request awaiting capacity allocation using the selected prioritization policy, as well as assigning available capacity to one or more proposal requests based on priority score.

Step 208 includes selecting a prioritization policy from the multiple prioritization policies based on said expected revenue measures. Step 210 includes computing a priority score for each proposal request in a given set of proposal requests based on application of the selected prioritization policy to each proposal request in the given set. The techniques depicted in FIG. 2 can additionally include prioritizing execution of said given set of proposal requests based on said computed priority scores.

Further, the techniques depicted in FIG. 2 can also include storing each of the multiple prior proposal requests in a repository, wherein each of the multiple prior proposal requests can be represented in the repository as a vector in a vector space based on one or more factors. Such factors can include, for example, proposal request context, value associated with each proposal request, proposal request receipt date, proposal development start date, and/or proposal completion date.

Additionally, at least one embodiment of the invention includes the steps of clustering multiple items of historical transaction data into one or more clusters based on transaction type, wherein said historical transaction data comprise multiple prior proposal requests; generating a logistic regression model for time sensitivity associated with each of the prior proposal requests within each of the one or more clusters; and simulating each of the prior proposal requests across the one or more clusters (i) based on the corresponding logistic regression model and (ii) under each of multiple prioritization policies to determine an expected revenue measure for each of the prior proposal requests under each of the prioritization policies. Further, such an embodiment also includes the steps of selecting a prioritization policy from the multiple prioritization policies for each transaction type based on said expected revenue measure for each of the proposal requests across the one or more clusters; and computing a priority score for each request in a given set of requests based on (i) identification of a transaction type associated with each request and (ii) implementation of the selected prioritization policy for said transaction type associated with each request.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

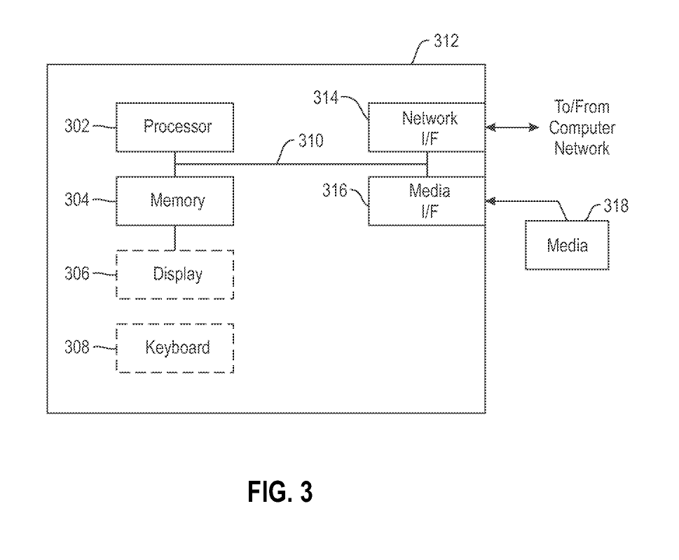

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, as noted herein, aspects of the present invention may take the form of a computer program product that may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, analyzing the time-sensitivity of multiple deals based on historical data, and identifying a prioritization rule that maximizes a total expected signing value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
clustering multiple items of historical proposal development data into one or more clusters based on one or more parameters, wherein said historical proposal development data comprise multiple prior proposal requests;
generating a logistic regression model for time sensitivity associated with each of the prior proposal requests within each of the one or more clusters;
simulating each of the prior proposal requests (i) based on the corresponding logistic regression model and (ii) under each of multiple prioritization policies to determine an expected revenue measure for each of the prior proposal requests under each of the prioritization policies;
selecting a prioritization policy from the multiple prioritization policies based on said expected revenue measures; and
computing a priority score for each proposal request in a given set of proposal requests based on application of the selected prioritization policy to each proposal request in the given set;
wherein at least one of said clustering, said generating, said simulating, said selecting, and said computing is carried out by a computing device.

2. The method of claim 1, comprising:
prioritizing execution of said given set of proposal requests based on said computed priority scores.

3. The method of claim 1, comprising:
storing each of the multiple prior proposal requests in a repository.

4. The method of claim 3, wherein each of the multiple prior proposal requests is represented in the repository as a vector in a vector space based on one or more factors.

5. The method of claim 4, wherein said one or more factors comprise proposal request context.

6. The method of claim 4, wherein said one or more factors comprise value associated with each proposal request.

7. The method of claim 4, wherein said one or more factors comprise proposal request receipt date.

8. The method of claim 4, wherein said one or more factors comprise proposal development start date.

9. The method of claim 4, wherein said one or more factors comprise proposal completion date.

10. The method of claim 1, wherein said generating comprises:
utilizing (i) a proposal request context measure, (ii) a value associated with a given proposal request, and (iii) a response time measure of the given proposal request as inputs; and
generating a win probability of the given proposal request as output.

11. The method of claim 10, wherein said response time comprises the time period between a request receipt date and a proposal completion date.

12. The method claim 1, wherein said simulating comprises computing available capacity for proposal development for a duration of simulation based on a proposal development start date and a completion date of each of the multiple prior proposal requests.

13. The method of claim 12, comprising:
computing, for each day of simulation, a priority score for each request awaiting capacity allocation using the selected prioritization policy.

14. The method of claim 12, comprising:
assigning available capacity to one or more proposal requests based on priority score.

15. The method of claim 1, wherein said multiple prioritization policies comprise a marginal penalty policy that determines a priority score based on a reduction in expected revenue of a given proposal request caused by delaying capacity allocation to the given proposal request by a given temporal interval.

16. A computer program product, the computer program product comprising a computer readable storage medium having program instructions embodied therewith, the program instructions executable by a computing device to cause the computing device to:
cluster multiple items of historical proposal development data into one or more clusters based on one or more parameters, wherein said historical proposal development data comprise multiple prior proposal requests;
generate a logistic regression model for time sensitivity associated with each of the prior proposal requests within each of the one or more clusters;
simulate each of the prior proposal requests (i) based on the corresponding logistic regression model and (ii) under each of multiple prioritization policies to determine an expected revenue measure for each of the prior proposal requests under each of the prioritization policies;
select a prioritization policy from the multiple prioritization policies based on said expected revenue measures; and
compute a priority score for each proposal request in a given set of proposal requests based on application of the selected prioritization policy to each proposal request in the given set.

17. The computer program product of claim 16, wherein said multiple prioritization policies comprise a marginal penalty policy that determines a priority score based on a reduction in expected revenue of a given proposal request caused by delaying capacity allocation to the given proposal request by a given temporal interval.

18. The computer program product of claim 16, wherein the program instructions executable by the computing device further cause the computing device to:
prioritize execution of said given set of proposal requests based on said computed priority scores.

19. A system comprising:
a memory; and
at least one processor coupled to the memory and configured for:
clustering multiple items of historical proposal development data into one or more clusters based on one or more parameters, wherein said historical proposal development data comprise multiple prior proposal requests;
generating a logistic regression model for time sensitivity associated with each of the prior proposal requests within each of the one or more clusters;
simulating each of the prior proposal requests (i) based on the corresponding logistic regression model and (ii) under each of multiple prioritization policies to determine an expected revenue measure for each of the prior proposal requests under each of the prioritization policies;
selecting a prioritization policy from the multiple prioritization policies based on said expected revenue measures; and
computing a priority score for each proposal request in a given set of proposal requests based on application of the selected prioritization policy to each proposal request in the given set.

20. A method comprising:
clustering multiple items of historical transaction data into one or more clusters based on transaction type, wherein said historical transaction data comprise multiple prior proposal requests;
generating a logistic regression model for time sensitivity associated with each of the prior proposal requests within each of the one or more clusters;
simulating each of the prior proposal requests across the one or more clusters (i) based on the corresponding logistic regression model and (ii) under each of multiple prioritization policies to determine an expected revenue measure for each of the prior proposal requests under each of the prioritization policies;
selecting a prioritization policy from the multiple prioritization policies for each transaction type based on said expected revenue measure for each of the proposal requests across the one or more clusters; and
computing a priority score for each request in a given set of requests based on (i) identification of a transaction type associated with each request and (ii) implementation of the selected prioritization policy for said transaction type associated with each request;
wherein at least one of said clustering, said generating, said simulating, said selecting, and said computing is carried out by a computing device.
